(19) United States
(12) Patent Application Publication
(10) Pub. No.: US 2006/0272157 A1
(43) Pub. Date: Dec. 7, 2006

(54) Foldable knife

(76) Inventor: Min Zheng Zeng, Nantou County (TW)

Correspondence Address: CHARLES E. BAXLEY, ESQ., 90 JOHN STREET, THIRD FLOOR, NEW YORK, NY, 10038, US

(21) Appl. No.: 11/147,134

(22) Filed: Jun. 7, 2005

(51) Int. Cl. B26B 1/04

(52) U.S. Cl. 30/161

(57) ABSTRACT

A foldable knife includes a housing, a blade holder, a first pivot member, a second pivot member, and a control knob. Thus, the blade is folded into the opening of the housing when not in use, thereby preventing the blade from causing danger to the user. In addition, the blade holder is juxtaposed to the housing when being folded to largely reduce the volume of the foldable knife, thereby facilitating the user carrying the foldable knife.

### BACKGROUND OF THE INVENTION

1. Field of the Invention

The present invention relates to a foldable knife, and more particularly to a foldable knife for cutting an article having a greater thickness, such as a wooden board, an acrylic board, a thicker paper board or the like.

2. Description of the Related Art

A conventional foldable knife is used for cutting an article having a greater thickness, such as a wooden board, an acrylic board, a thicker paper board or the like. The conventional foldable knife comprises a blade holder, and a blade retractably mounted on the blade holder. However, when the blade is retracted into the blade holder, the front end of the blade is protrude outward from the blade holder, thereby easily causing danger to the user.

### SUMMARY OF THE INVENTION

The present invention is to mitigate and/or obviate the disadvantage of the conventional foldable knife.

The primary objective of the present invention is to provide a foldable knife that is folded when not in use.

Another objective of the present invention is to provide a foldable knife, wherein the blade is folded into the opening of the housing when not in use, thereby preventing the blade from causing danger to the user.

A further objective of the present invention is to provide a foldable knife, wherein the blade holder is juxtaposed to the housing when being folded to largely reduce the volume of the foldable knife, thereby facilitating the user carrying the foldable knife.

A further objective of the present invention is to provide a foldable knife, wherein the locking portion of the control knob is locked in either one of the first limit groove and the second limit groove of the limit ring so that the blade holder is fixed on the housing by the control knob and cannot be freely moved relative to the housing.

In accordance with the present invention, there is provided a foldable knife, comprising a housing having an inside and a side formed with an opening communicating with the inside of the housing, a blade holder pivotally mounted on an end of the housing and having a first end having a side formed with a limit ring rotatably mounted in the housing and a second end provided with a blade, the limit ring having a periphery formed with a first limit groove and a second limit groove located radially opposite to the first limit groove, and a control knob movably mounted on the housing and having a side provided with a locking portion extended through the housing and detachably locked in either one of the first limit groove and the second limit groove of the limit ring.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a foldable knife in accordance with the preferred embodiment of the present invention;

FIG. 2 is an exploded perspective view of the foldable knife as shown in FIG. 1;

FIG. 3 is a partially plan cross-sectional view of the foldable knife as shown in FIG. 1;

FIG. 4 is a schematic operational view of the foldable knife as shown in FIG. 3;

FIG. 5 is a schematic operational view of the foldable knife as shown in FIG. 4;

FIG. 6 is a schematic operational view of the foldable knife as shown in FIG. 5; and

FIG. 7 is a schematic operational view of the foldable knife as shown in FIG. 1.

### DETAILED DESCRIPTION OF THE INVENTION

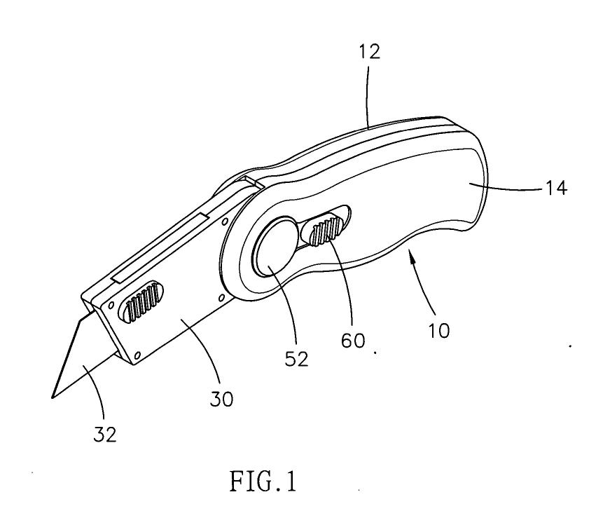

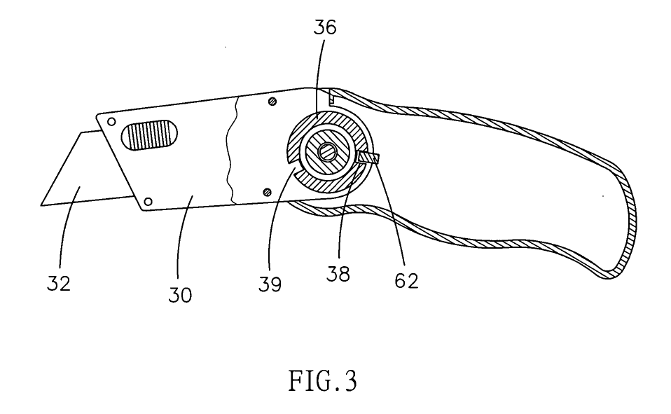

Referring to the drawings and initially to FIGS. 1-3, a foldable knife in accordance with the preferred embodiment of the present invention comprises a housing 10, a blade holder 30, a first pivot member 52, a second pivot member 54, and a control knob 60.

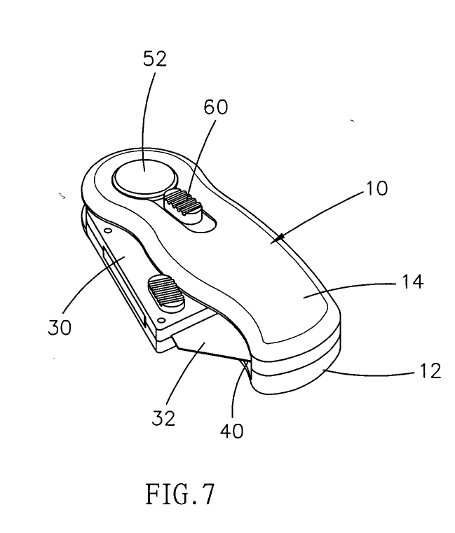

The housing 10 includes a first casing 12, and a second casing 14 combined with the first casing 12. The first casing 12 has a periphery formed with a first lip 16 and has an end portion formed with a first pivot portion 24. The second casing 14 has a periphery formed with a second lip 18 juxtaposed to the first lip 16 of the first casing 12 and has an end portion formed with a second pivot portion 26 juxtaposed to the first pivot portion 24 of the first casing 12. Each of the first lip 16 of the first casing 12 and the second lip 18 of the second casing 14 has a side formed with a depression 22, thereby defining an opening 40 (see FIG. 7) between the first lip 16 of the first casing 12 and the second lip 18 of the second casing 14 when the second casing 14 is combined with the first casing 12. The opening 40 communicates with an inside of the housing 10.

The blade holder 30 is pivotally mounted on the housing 10 and located 11 between the first casing 12 and the second casing 14. The blade holder 30 has a first end having a side formed with a limit ring 36 rotatably mounted in the second casing 14 and a second end provided with a blade 32. The limit ring 36 has a periphery formed with a first limit groove 38 and a second limit groove 39 located radially opposite to the first limit groove 38. The limit ring 36 has an inside formed with a pivot hole 34 pivotally mounted on the first pivot portion 24 of the first casing 12 and the second pivot portion 26 of the second casing 14 so that the blade holder 30 is pivotally mounted on the housing 10 between the first casing 12 and the second casing 14.

The first pivot member 52 is mounted on the second casing 14 and has a distal end extended through the second pivot portion 26 of the second casing 14 and the first pivot portion 24 of the first casing 12, and the second pivot member 54 is secured on the distal end of the first pivot member 52 and rested on the first casing 12.

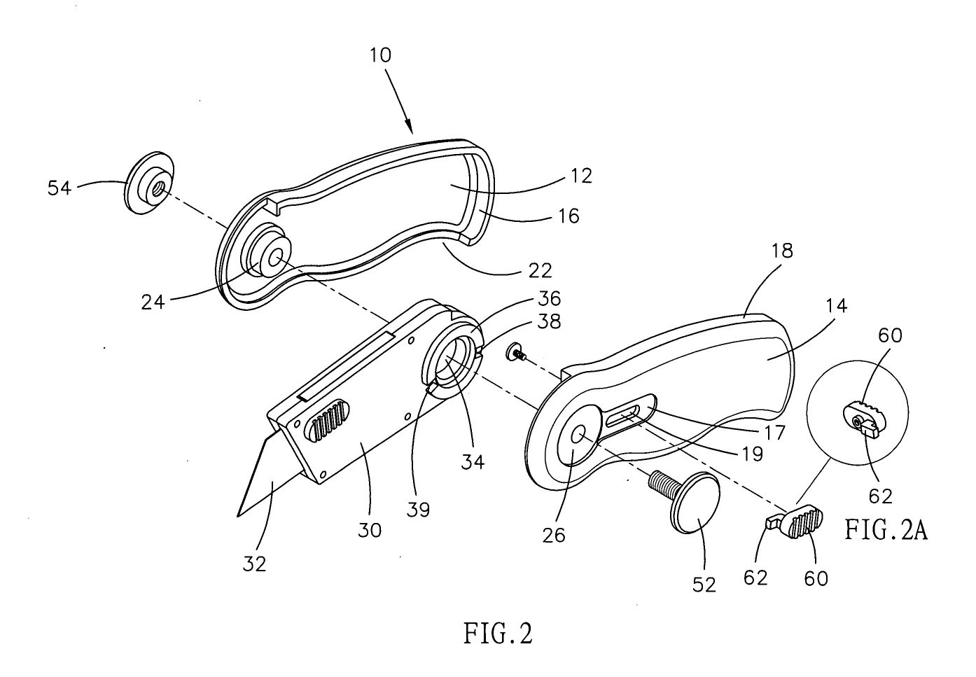

The control knob 60 is movably mounted on the second casing 14 and has a side provided with a locking portion 62 (see FIG. 2A) extended through the second casing 14 and detachably locked in either one of the first limit groove 38 and the second limit groove 39 of the limit ring 36. The second casing 14 has a side formed with a guide slot 19 to allow passage and to guide movement of the locking portion 62 of the control knob 60 and a slideway 17 to guide movement of the control knob 60. The locking portion 62 of the control knob 60 is substantially L-shaped and is protruded outward from the control knob 60.

Referring to FIGS. 1-3, when the blade holder 30 is expanded outward relative to the housing 10, the blade 32 is protruded outward for use with a user. At this time, the locking portion 62 of the control knob 60 is locked in the first limit groove 38 of the limit ring 36 so that the blade holder 30 is fixed on the housing 10 by the control knob 60 and cannot be moved relative to the housing 10.

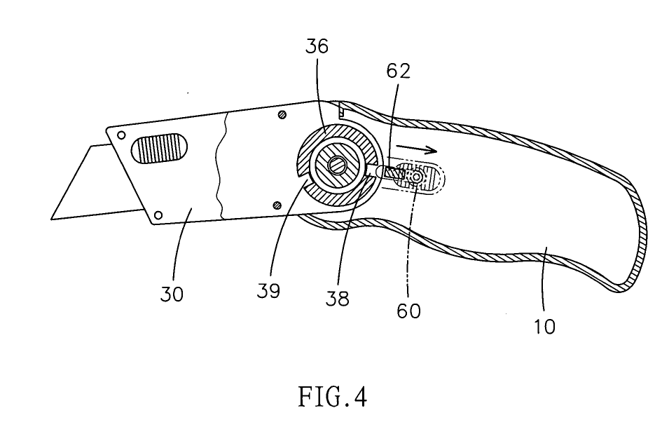

Referring to FIG. 4, the control knob 60 is pushed to move the locking portion 62 to detach from the first limit groove 38 of the limit ring 36 so that the blade holder 30 is unlocked from the control knob 60 and can be pivoted relative to the housing 10.

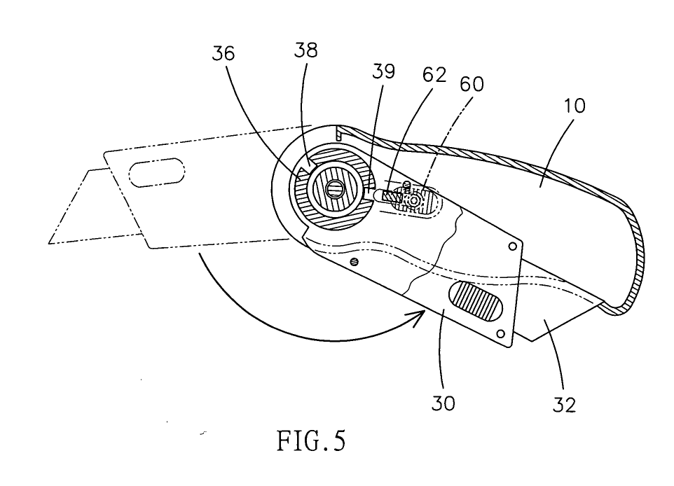

Referring to FIG. 5, the blade holder 30 is pivoted relative to the housing 10 until the locking portion 62 of the control knob 60 is aligned with the second limit groove 39 of the limit ring 36.

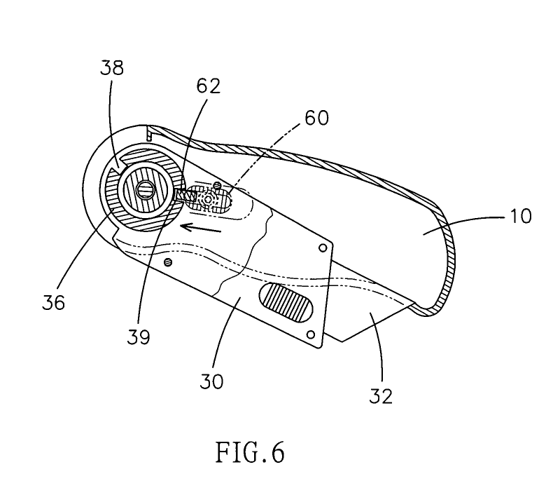

Referring to FIG. 6, the control knob 60 is pushed to move the locking portion 62 to lock the locking portion 62 in the second limit groove 39 of the limit ring 36 so that the blade holder 30 is fixed on the housing 10 by the control knob 60 and cannot be moved relative to the housing 10.

Referring to FIGS. 6 and 7, when the blade holder 30 is folded onto the housing 10, the blade 32 is folded into the opening 40 of the housing 10. At this time, the locking portion 62 of the control knob 60 is locked in the second limit groove 39 of the limit ring 36 so that the blade holder 30 is fixed on the housing 10 by the control knob 60 and cannot be moved relative to the housing 10.

Accordingly, the blade 32 is folded into the opening 40 of the housing 10 when not in use, thereby preventing the blade 32 from causing danger to the user. In addition, the blade holder 30 is juxtaposed to the housing 10 when being folded to largely reduce the volume of the foldable knife, thereby facilitating the user carrying the foldable knife. Further, the locking portion 62 of the control knob 60 is locked in either one of the first limit groove 38 and the second limit groove 39 of the limit ring 36 so that the blade holder 30 is fixed on the housing 10 by the control knob 60 and cannot be freely moved relative to the housing 10.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A foldable knife, comprising:
a housing having an inside and a side formed with an opening communicating with the inside of the housing;
a blade holder pivotally mounted on an end of the housing and having a first end having a side formed with a limit ring rotatably mounted in the housing and a second end provided with a blade;
the limit ring having a periphery formed with a first limit groove and a second limit groove located radially opposite to the first limit groove;
a control knob movably mounted on the housing and having a side provided with a locking portion extended through the housing and detachably locked in either one of the first limit groove and the second limit groove of the limit ring.

2. The foldable knife in accordance with claim 1, wherein when the locking portion of the control knob is locked in the first limit groove of the limit ring, the blade holder is expanded outward relative to the housing, and the blade is protruded outward.

3. The foldable knife in accordance with claim 1, wherein when the locking portion of the control knob is locked in the second limit groove of the limit ring, the blade holder is folded onto the housing, and the blade is folded into the opening of the housing.

4. The foldable knife in accordance with claim 3, wherein the blade holder is juxtaposed to the housing when being folded.

5. The foldable knife in accordance with claim 1, wherein when the locking portion of the control knob is locked in either one of the first limit groove and the second limit groove of the limit ring, the blade holder is fixed on the housing by the control knob and cannot be moved relative to the housing.

6. The foldable knife in accordance with claim 1, wherein when the locking portion of the control knob is detached from either one of the first limit groove and the second limit groove of the limit ring, the blade holder is unlocked from the control knob and can be pivoted relative to the housing.

7. The foldable knife in accordance with claim 1, wherein the housing includes a first casing, and a second casing combined with the first casing, the first casing has a periphery formed with a first lip, the second casing has a periphery formed with a second lip juxtaposed to the first lip of the first casing.

8. The foldable knife in accordance with claim 7, wherein each of the first lip of the first casing and the second lip of the second casing has a side formed with a depression, thereby defining the opening between the first lip of the first casing and the second lip of the second casing.

9. The foldable knife in accordance with claim 7, wherein the first casing has an end portion formed with a first pivot portion, the second casing has an end portion formed with a second pivot portion juxtaposed to the first pivot portion of the first casing, and the limit ring has an inside formed with a pivot hole pivotally mounted on the first pivot portion of the first casing and the second pivot portion of the second casing so that the blade holder is pivotally mounted on the housing between the first casing and the second casing.

10. The foldable knife in accordance with claim 9, further comprising a first pivot member mounted on the second casing and having a distal end extended through the second pivot portion of the second casing and the first pivot portion of the first casing, and a second pivot member secured on the distal end of the first pivot member and rested on the first casing.

11. The foldable knife in accordance with claim 7, wherein the control knob is movably mounted on the second casing.

12. The foldable knife in accordance with claim 7, wherein the second casing has a side formed with a guide slot to allow passage and to guide movement of the locking portion of the control knob.

13. The foldable knife in accordance with claim 7, wherein the second casing has a side formed with a slideway to guide movement of the control knob.

14. The foldable knife in accordance with claim 1, wherein the locking portion of the control knob is substantially L-shaped.

15. The foldable knife in accordance with claim 1, wherein the locking portion of the control knob is protruded outward from the control knob.
